(19) United States
(12) Patent Application Publication
(10) Pub. No.: US 2014/0153270 A1
(43) Pub. Date: Jun. 5, 2014

(54) Light assembly for bicycle seat post

(71) Applicant: Yen-Pin Lai, Changhua (TW)

(72) Inventor: Yen-Pin Lai, Changhua (TW)

(21) Appl. No.: 14/180,365

(22) Filed: Feb. 14, 2014

(51) Int. Cl. B62J 6/04

(52) U.S. Cl. CPC B62J 6/04
USPC 362/473

(57) ABSTRACT

A light assembly mounted in recess of a seat post of a bicycle is provided with a push button moveably mounted on a mouth of the recess and including a bossed hole on a rear surface; a resilient conductor fastened in the bossed hole; a controller circuit fastened in the recess and including two spaced contacts spaced from the conductor in a non-depressed position, the contacts being electrically connected to the controller circuit; LEDs disposed on a front surface of the controller circuit facing the rear surface of the push button; and a battery mounted to a rear surface of the controller circuit and electrically connected to the contacts. A pressing of the push button electrically connects the conductor to the contacts so that an electric energy is supplied from the battery to the LEDs for illumination via the contacts, the conductor, and the controller circuit.

### BACKGROUND OF THE INVENTION

1. Field of the Invention

The invention relates to bicycle lights and more particularly to a light assembly mounted in a seat post of a bicycle.

2. Description of Related Art

A conventional bicycle lighting device comprises three pieces of transparent flexible plastic tubing, each piece provided with two rows of longitudinally spaced light-emitting diodes (LEDs) embedded at diametrically opposed locations along the tube. Each piece of tubing is longitudinally slit for insertion around a frame tube of a bicycle. The three tubes are connected by electrical wiring and are also connected to a battery pack which includes a sequencing circuit for flashing the LEDs in sequence. The three tubes are fastened in a triangular configuration on the bicycle frame tubes and provide a broadside flashing signal so that approaching motorists may pay close attention to the bicycle rider.

Notwithstanding the prior art, the invention is neither taught nor rendered obvious thereby.

### SUMMARY OF THE INVENTION

It is therefore one object of the invention to provide a light assembly mounted in recess of a seat post of a bicycle comprising, in combination a push button moveably mounted on a mouth of the recess and including a bossed hole on a rear surface; a resilient conductor fastened in the bossed hole; a controller circuit fastened in the recess and including two spaced contacts spaced from the conductor in a non-depressed position, the contacts being electrically connected to the controller circuit; a plurality of LEDs disposed on a front surface of the controller circuit facing the rear surface of the push button; and a battery mounted to a rear surface of the controller circuit and electrically connected to the contacts; wherein a pressing of the push button electrically connects the conductor to the contacts so that an electric energy is supplied from the battery to the LEDs for illumination via the contacts, the conductor, and the controller circuit.

The above and other objects, features and advantages of the invention will become apparent from the following detailed description taken with the accompanying drawings.

### BRIEF DESCRIPTION OF THE DRAWINGS

FIG. 1 is an exploded view of a light assembly to be mounted in a recess of a seat post of a bicycle according to a first preferred embodiment of the invention;

FIG. 2 is a perspective, sectional view of the seat post;

FIG. 3 is a longitudinal sectional view of the seat post with the light assembly mounted in the recess;

FIG. 4 is a view similar to FIG. 3 with the push button pressed to turn on the light assembly;

FIG. 5 is a perspective view of the saddle area with the light assembly being turned on;

FIG. 6 is a side elevation of a bicycle incorporating the light assembly;

FIG. 7A is an exploded view of a light assembly to be mounted in a recess of a seat post of a bicycle according to a second preferred embodiment of the invention;

FIG. 7B is a perspective, sectional view of the seat post shown in FIG. 7A; and

FIG. 8 is a longitudinal sectional view of the seat post of FIG. 7A with the light assembly mounted in the hole of the seat post.

### DETAILED DESCRIPTION OF THE INVENTION

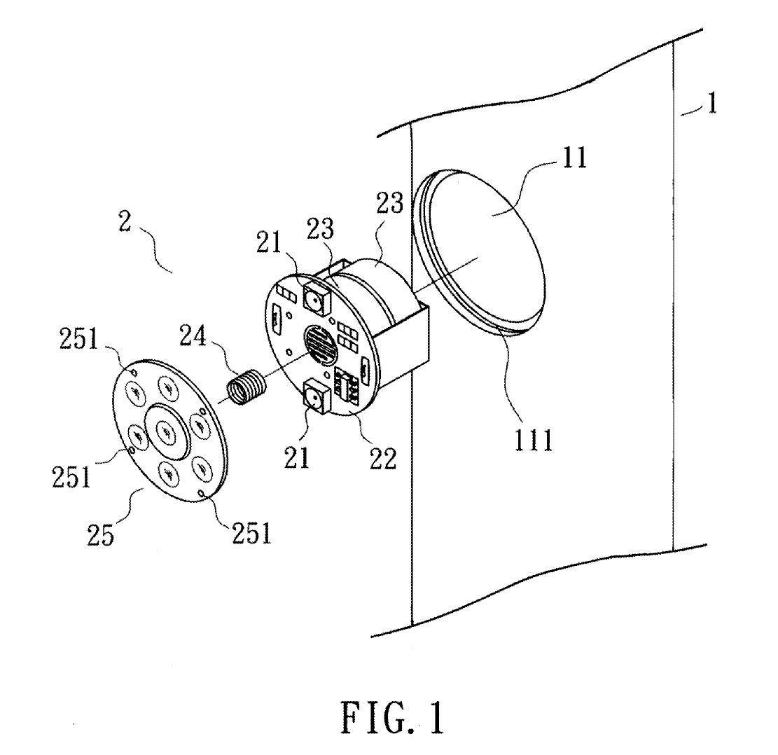

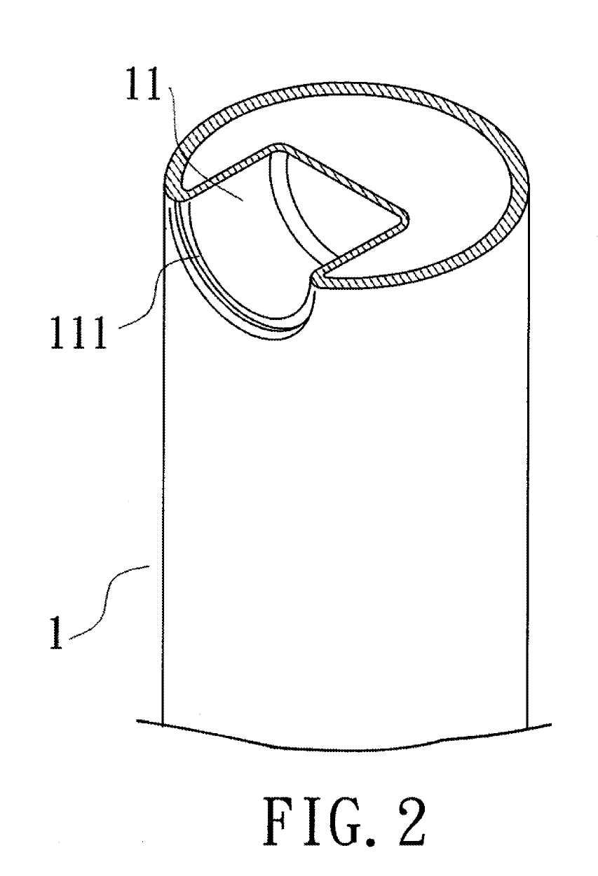

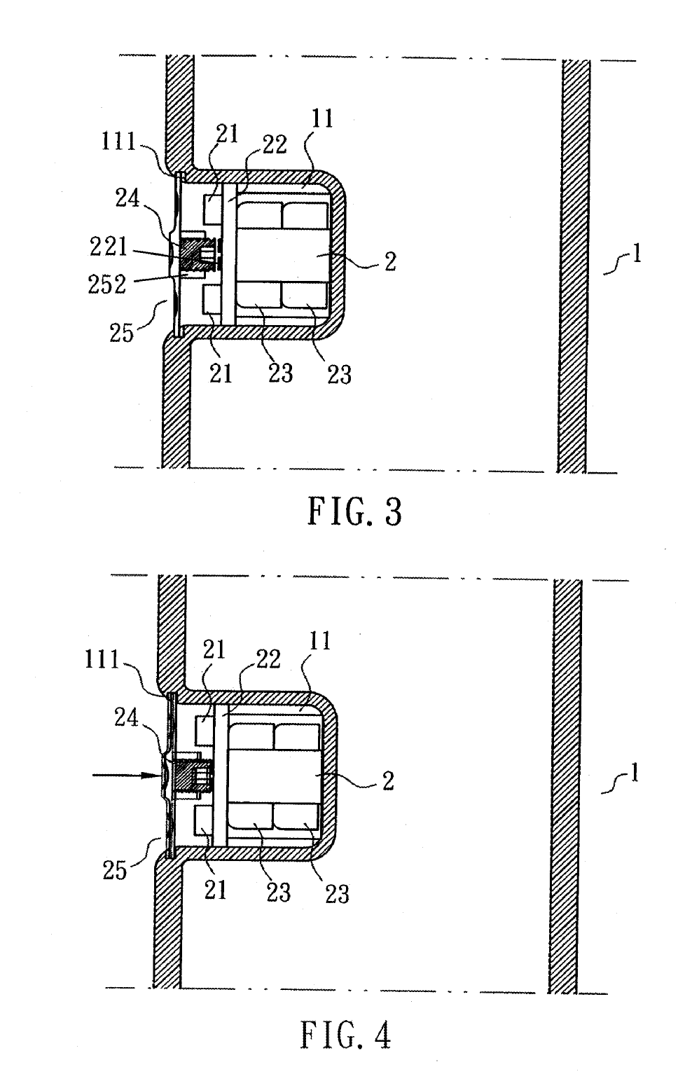

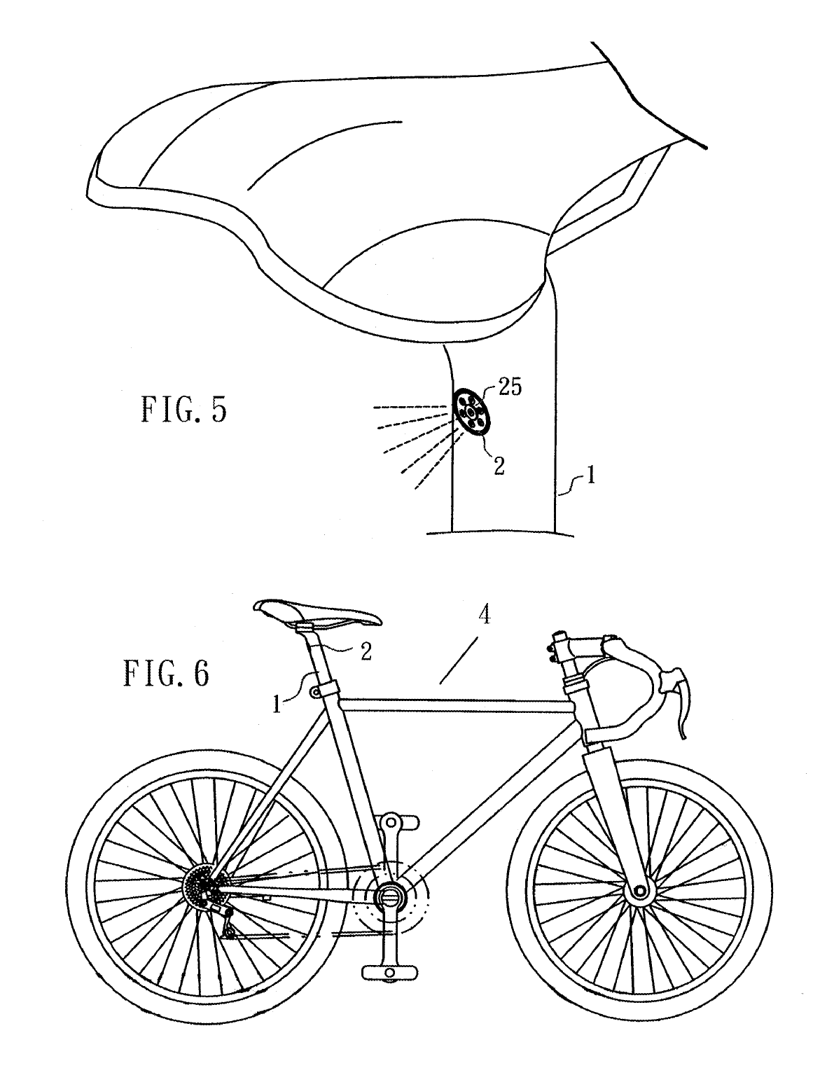

Referring to FIGS. 1 to 6, a light assembly 2 in accordance with a first preferred embodiment of the invention is shown. The light assembly 2 is mounted in a recess 11 of a seat post 1 of a bicycle 4. The recess 11 is cylindrical and has an annular groove 111 on the mouth. The light assembly 2 comprises the following components as discussed in detail below.

A push button 25 is formed of translucent flexible plastic and shaped as a disc. The push button 25 comprises a plurality of holes 251 adjacent to the edge. A cylindrical, resilient conductor 24 is anchored a bossed hole 252 on a rear surface of the push button 25. A disc-shaped controller circuit 22 comprises two spaced contacts 221 on a central portion and spaced from the conductor 24 in a non-depressed position. Two opposite LEDs 21 are provided on a front surface of the controller circuit 22 facing a rear surface of the push button 25. Two cells 23 are mounted to a rear surface of the controller circuit 22 and are electrically connected to the contacts 221 which are electrically connected to the controller circuit 22. The controller circuit 22 is fastened in the recess 11. The push button 25 is fitted onto the groove 111 by snapping. Further, a plurality of fasteners (not shown) are driven through the holes 251 into the mouth of the recess 11 to moveably secure the push button 25 to the seat post 1. For activating the light assembly 2, a rider may press the push button 25 to electrically connect the conductor 24 to the contacts 221. Thus, an electric energy is supplied from the cells 23 to the LEDs 21 for illumination via the contacts 221, the conductor 24, and the controller circuit 22. For deactivating the light assembly 2, the rider may press the push button 25 again to disengage the conductor 24 from the contacts 221.

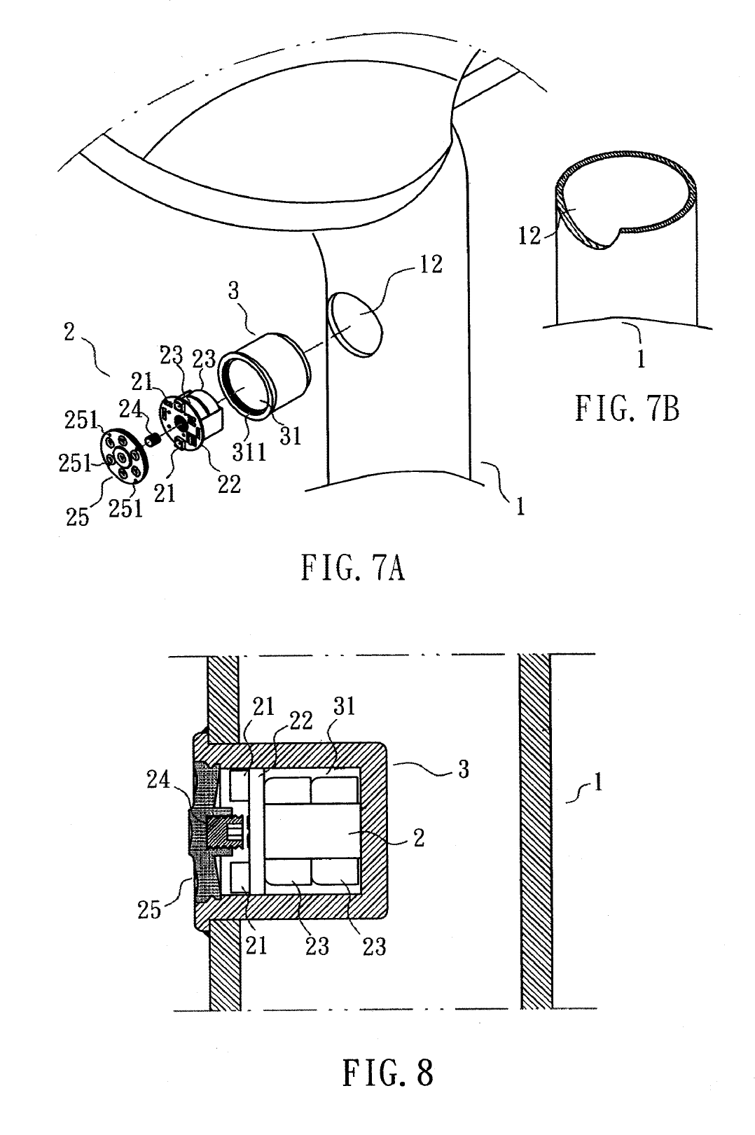

Referring to FIGS. 7A to 8, a light assembly 2 in accordance with a second preferred embodiment of the invention is shown. The characteristics of the second preferred embodiment are substantially the same as that of the first preferred embodiment except the following:

The light assembly 2 is mounted in a hollow, cylindrical housing 3 having one end open and the other end closed. Further, the housing 3 is disposed in a hole 12 of a seat post 1 of a bicycle (not numbered). The hollow housing 3 comprises an interior 31 having an annular groove 311 on the mouth. The light assembly 2 is disposed in the interior 31 with the push button 25 releasably secured to the groove 311.

While the invention has been described in terms of preferred embodiments, those skilled in the art will recognize that the invention can be practiced with modifications within the spirit and scope of the appended claims.

What is claimed is:

1. A light assembly mounted in a recess of a seat post of a bicycle comprising, in combination:
a push button moveably mounted on a mouth of the recess and comprising a bossed hole on a rear surface;
a resilient conductor fastened in the bossed hole;
a controller circuit fastened in the recess and comprising two spaced contacts spaced from the conductor in a non-depressed position, the contacts being electrically connected to the controller circuit;
a plurality of LEDs disposed on a front surface of the controller circuit facing the rear surface of the push button; and
a battery mounted to a rear surface of the controller circuit and electrically connected to the contacts;
wherein a pressing of the push button electrically connects the conductor to the contacts so that an electric energy is supplied from the battery to the LEDs for illumination via the contacts, the conductor, and the controller circuit.
